(19) United States
(12) Patent Application Publication
(10) Pub. No.: US 2009/0130428 A1
(43) Pub. Date: May 21, 2009

(54) Transparent optical substrate with elements distributed therein, method of producing and application of the same

(75) Inventors: Herve Meillat, Avignon les Saint-Claude (FR); Nathalie Boyer, Mijoux (FR); Nicolas Parent, Saint-Claude (FR)

Correspondence Address: OLIFF & BERRIDGE, PLC, P.O. BOX 320850, ALEXANDRIA, VA, 22320-4850, US

(73) Assignee: CHRISTIAN DALLOZ SUNOPTICS, Saint-Claude (FR)

(21) Appl. No.: 12/289,444

(22) Filed: Oct. 28, 2008

(30) Foreign Application Priority Data
Nov. 16, 2007 (FR) 07/08040

(51) Int. Cl. B32B 5/16; B29D 11/00

(52) U.S. Cl. 428/323; 264/1.31

(57) ABSTRACT

A substrate made of a transparent inorganic or organic material, with transparent elements distributed through its volume, even in the visual field of a wearer of said substrate, and incident light is partly reflected and partly transmitted. The elements may undergo surface treatment to render them even more light-reflecting. A method of producing the above substrate and an application of the above substrate as optical elements.

### BACKGROUND

The present disclosure relates to a novel transparent optical substrate, the method for producing the same, and its application as an optical element.

Optical elements throughout which, or at the surface of which, spangles are disposed are known. The spangles used are opaque and are intended for decoration of the optical element because they can, for example, be disposed on eyeglass frames or form motifs on the lenses of said eyeglasses.

Contact lenses are also known in which the portion covering the iris is provided with spangles conferring on said contact lenses a purely decorative effect on the iris alone, the spangles being absent from the visual field of the wearer.

U.S. Pat. No. 4,989,967, for example, teaches a substrate containing reflecting or fluorescent elements, but the elements (or spangles) contained in the optical substrate do not correspond to the elements that are the subject of this disclosure in terms of their characteristics (composition, dimensions, and concentration) and do not produce the same effects as those obtained for the optical substrate which is the subject of this disclosure.

Embodiments of the present disclosure have a wholly different approach: the elements integrated into the substrate are designed to produce a specific luminous visual effect, namely brightness and glitter under certain lighting conditions.

### SUMMARY

Embodiments of the present disclosure provide an optical substrate or optical element, as defined hereinbelow, producing glitter, solely under the action of medium to strong lighting, without thereby interfering with the vision of the wearer. In the case of low lighting, this glitter will not be detectable by an observer and the elements contained in said substrate will not be visible to said observer.

An optical substrate is understood to be, for example, a material designed to be viewed as transparent by a wearer. The material referred to in the present description is of the type generally used in the optics field and can thus consist of mineral glass or an organic material, such as polycarbonate or polyamide, a thermoplastic or thermosetting resin, or other materials known in the art. This substrate can thus be in the form of a screen, but can also advantageously consist of an optical element.

An optical element is, for example, a device designed to be placed in front of the eyes of a wearer, whether it be an eyeglass lens (particularly in sunglasses), or visors of masks or helmets (for example for sports or occupational use, but also for protection of motorcycle police officers or motorcyclists). Thus, the eyeglass lenses to which the present description refers can be sunglass or non-sunglass lenses; corrective or non-corrective lenses; and relates to ophthalmic lenses and other lenses and elements known in the art.

More specifically, the optical substrate according to embodiments of the present disclosure is composed of a material in which reflecting transparent elements are distributed randomly in the volume of said substrate (even in the visual field of the wearer of said substrate), wherein said elements have an oblong shape with a width of between 10 and 30 microns, a length of between 100 and 300 microns, a thickness of 0.5 to 1.5 microns, and said elements having a concentration in the substrate of a few parts per million (ppm) to a few tens of ppm, such as from about 2 ppm to about 30 ppm, or from about 2 ppm to about 20 ppm.

In embodiments, said elements are approximately 20 microns wide, approximately 200 microns long, and have a thickness being approximately 1 micron.

Advantageously, said elements have a concentration in the substrate of about ten ppm.

According to an embodiment of the disclosure, said elements are made of calcium and aluminum borosilicate.

In embodiments, a surface treatment of the elements will be provided, consisting of depositing metal oxides on said elements.

### BRIEF DESCRIPTION OF THE DRAWINGS

The disclosure will be better understood by reading the description below with reference to the drawings, wherein:

FIG. 1 is a cross section of a conventional substrate;

FIG. 2 is a cross section of a substrate according to an embodiment of the present disclosure; and

FIG. 3 is a cross section of a substrate according to a variant embodiment of the present disclosure.

### DETAILED DESCRIPTION OF EMBODIMENTS

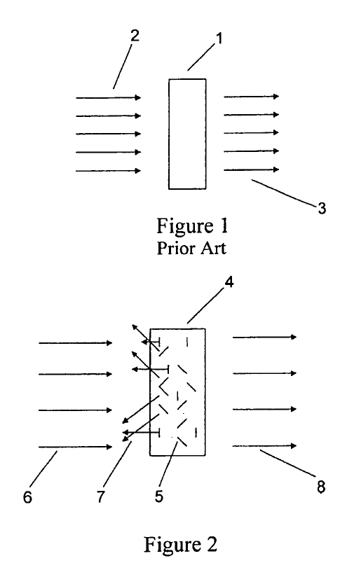

FIG. 1 shows, in cross section, a conventional substrate (1) on which incident light (2) impinges and which allows transmitted light (3) to pass through. Some of the light (2) will be absorbed by any pigments/dyes contained in substrate (1).

FIG. 2 shows, in cross section, a substrate (4) according to an embodiment of the present disclosure wherein transparent reflecting elements (or elements that have undergone surface treatment to render them light-reflecting or more light-reflecting) (5) have been distributed randomly such that the incident light (6) is partly reflected (7) and partly transmitted (8), another part of this incident light (6) being absorbed by any pigments/dyes that said substrate (4) contains.

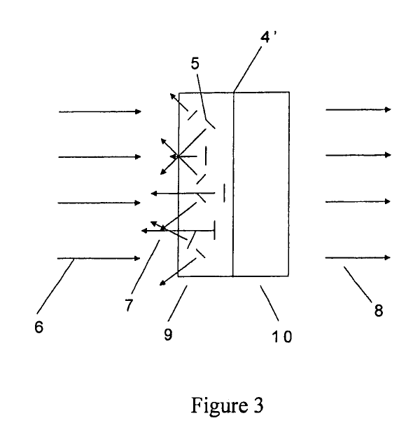

FIG. 3 shows, in cross section, a substrate according to one variant embodiment of the present disclosure, wherein the substrate, referenced (4′) overall, is comprised of two layers (9) and (10), each made of a material as defined above, where the distribution of the elements (5) is no longer homogenous in the volume of the substrate, as shown in FIG. 2. In the embodiment shown in FIG. 3, the elements (5) are grouped into layer (9), namely the part of the substrate on the observer's side, the layer (10) being on the wearer's side. The material of layer (9) can be identical in composition to the material of layer (10), but these materials can also be of different compositions.

A number of embodiments are possible without thereby departing from the framework of the present disclosure. According to one embodiment, not illustrated here, the substrate can have more than two layers. Likewise, the elements (5) can be grouped into a single layer as shown in FIG. 3, but substrates with several layers can also be made where the concentration of elements (5) differ from one layer to another without said elements (5) being thereby grouped into a single layer. It is also possible to provide elements (5) whose nature varies according to the layer in which they are located.

The orientation of elements (5) is random so that each element reflects the incident light (6) in a preferred direction shown by arrows (7). Because of this arrangement, an observer located in the path of the reflected light (7) will perceive a luminous visual effect when the incident light (6) is of medium or high intensity, such as that coming from the sun or a halogen lamp. In the absence of such medium- or high-intensity light, the elements (5) will not be visible by an observer, so that said elements will not contribute any decorative features to the substrate according to embodiments of the present disclosure. This luminous visual effect will be a bright, glittering effect when the position of said observer varies relative to the substrate (4). Thus, the effect will depend both on the angle of incidence of the light (6) and the position of said observer.

The characteristics of elements (5) are chosen such that, in transmission, said elements are not visible to the naked eye, the transmitted light (8) being the same as that transmitted by the substrate without the elements shown in FIG. 1. On the other hand, in reflection, said elements (5) are rendered visible by reflection of the incident light (6) on said elements (5). Thus, when said substrate (4) constitutes an optical element as defined above, the luminous visual effect will be imperceptible to the wearer of said optical element. In fact, the wearer should not to be disturbed by the presence of these elements (5) when said elements (5) are in his or her visual field. Moreover, transmission of light through the substrate (4) should not be significantly affected by elements (5).

To meet these various requirements, these elements (5) are made of a transparent material such as, for example, calcium and aluminum borosilicate, which is either naturally reflecting or has undergone surface treatment that produces or reinforces this reflecting aspect by deposition of metal oxides, for example, such as TiO₂ or SnO₂. This treatment can also consist of depositing metal, metalloid, or metalloid oxide such as, for example, SiO₂. Depending on the color the glitter is to receive, an appropriate product or products (metal, metalloid, or oxides thereof) will be chosen. The glitter can be, depending on the choice of said products, including, but not limited to, copper-colored, gold, blue, green, red, turquoise, pink, or white. This color will vary according to the thickness of the layer or layers of said selected products and according to the number of layers applied using some of these products.

The aforesaid surface treatment is necessary when the elements (5) are not themselves reflecting. It also may be useful to perform such a surface treatment on the elements (5) that are already reflecting by themselves, but for which it is desired to reinforce this light-reflecting characteristic.

According to various embodiments of the present disclosure, the elements (5) have an oblong shape with a width advantageously between 10 and 30 microns, such as about 20 microns, and a length advantageously between 100 and 300 microns, such as about 200 microns. The thickness of such elements (5) is advantageously between 0.5 and 1.5 microns, such as about 1 micron. Moreover, the concentration by weight of these elements within said substrate is between a few ppm and a few tens of ppm, such as from about 2 ppm to about 30 ppm, or from about 2 ppm to about 20 ppm relative to the weight of the material of which said substrate is made. According to one embodiment of the disclosure, said concentration is approximately ten ppm. Indeed, and surprisingly, the desired glittering effect appeared under the aforesaid lighting conditions without interfering with the vision of the wearer, and it could be obtained only using both this dimensional range of elements (5) and this concentration range of said elements.

Other embodiments of the present disclosure relate to a method of producing the substrate according to the various embodiments of the present disclosure.

Typically, the elements (5) described above are mixed with plastic granules, and optionally with pigments/dyes. The mixture thus obtained is melted, then injected into a suitable mold. According to another embodiment, the elements (5) are mixed with a thermoplastic or thermosetting resin, pigments/dyes can optionally be added, the mixture is then cast or molded in a suitable mold.

According to yet another embodiment, corresponding to a substrate composed of several layers as described above and illustrated, for example, in FIG. 3, a first layer is made according to one of the methods described above; then a second layer, also produced by one of the above methods, is molded over said first layer, and the operation can be repeated according to the number of layers desired. The elements (5) will be present or absent, as the case may be, in each of the layers with the same concentration or a different concentration.

When the material of the present disclosure is an optical element, as defined above, the characteristics of elements (5), namely their size, shape, composition and concentration, as these characteristics have been described above in embodiments, take into account the color of said optical element, its thickness, and its surface treatment if any, so that the final optical element abides by sunglass standards. Thus, the optical elements according to embodiments of the present disclosure integrated into sunglasses, for example, respect the limitations of light diffusion, do not interfere with the vision of the wearer, and are suitable for wear when driving. More generally, these optical elements meet the same requirements as standard sunglass optical elements. Moreover, the optical elements according to embodiments of the present disclosure have the above characteristics and meet all the standards covering sunglass optical elements, in particular the diffused light standard according to EN1836:2006. The main drawback to optical elements containing classical inclusions is that they do not meet this standard, thus such lenses do not meet the standards on sunglass optical elements. More generally, the optical elements made according to the present disclosure meet French and international “Eye Protection” standards.

Other variants may be considered for the optical elements or substrates according to the present disclosure; thus, according to one of these variants concerning optical elements, surface treatment of said optical elements will be applied to said optical elements on the wearer side of the latter and/or on the observer side, for example in order to render the glitter effect still more intense. The substrates according to the present disclosure can be treated in the same manner.

1. A transparent optical substrate comprising reflecting transparent elements, wherein:
the elements are distributed randomly in the volume of the substrate including in the visual field of the wearer of the substrate;
the elements have an oblong shape with a width of between 10 and 30 microns, a length of between 100 and 300 microns, and a thickness of 0.5 to 1.5 microns; and
a concentration of the elements in the substrate is from a few ppm to a few tens of ppm relative to the weight of the substrate material.

2. An optical substrate according to claim 1, wherein the elements have undergone a surface treatment making them more light-reflecting.

3. An optical substrate according to claim 1, wherein the elements are approximately 20 microns wide, approximately 200 microns long, and have a thickness being approximately 1 micron.

4. An optical substrate according to claim 1, wherein the elements have a concentration from about 2 ppm to about 30 ppm relative to the weight of the substrate.

5. An optical substrate according to claim 1, wherein the elements have a concentration in the substrate of about ten ppm.

6. An optical substrate according to claim 1, wherein the elements have a deposit of at least a metal oxide at their surface.

7. An optical substrate according to claim 1, wherein the elements are made of calcium and aluminum borosilicate.

8. An optical substrate according to claim 1, wherein the elements are uniformly distributed within said substrate.

9. An optical substrate according to claim 1, wherein the substrate comprises a plurality of layers.

10. An optical substrate according to claim 8, wherein the elements are grouped into the layer located on the observer side of said substrate.

11. A method of producing the substrate according to claim 1, wherein the elements are mixed with plastic granules, the mixture thus obtained being melted and then injected into an appropriate mold.

12. A method of producing the substrate according to claim 1, wherein the elements are mixed with a thermoplastic or thermosetting resin, the mixture thus obtained then being cast or molded in an appropriate mold.

13. A method of producing the substrate according to claim 8, wherein
a first layer is produced by mixing elements with plastic granules, the mixture thus obtained being melted and then injected into an appropriate mold, and
at least one other layer being overmolded onto said first layer.

14. A method according to claim 10, wherein pigments/dyes are added.

15. An Optical element made from the substrate of claim 1.

16. A transparent optical substrate comprising reflecting elements, wherein:
the elements are distributed randomly in the volume of the substrate including in the visual field of the wearer of the substrate;
the elements have an oblong shape with a width of approximately 20 microns, a length of approximately 200 microns, and a thickness of approximately 1 micron; and
a concentration of the elements in the substrate is about ten ppm relative to the weight of the substrate material.

17. An optical element made from the substrate of claim 16.

18. Eyeglasses comprising the optical element of claim 15.

19. Sunglasses comprising the optical element of claim 15.

20. Eyeglasses comprising the optical element of claim 17.
